(19) United States
(12) Patent Application Publication
(10) Pub. No.: US 2009/0302573 A1
(43) Pub. Date: Dec. 10, 2009

(54) DUMP TRAILER COUPLING APPARATUS

(76) Inventor: Charles J. Nye, JR., Lewiston, ME (US)

Correspondence Address: CHRIS A. CASEIRO, VERRILL DANA, LLP, ONE PORTLAND SQUARE, PORTLAND, ME, 04112-0586, US

(21) Appl. No.: 12/134,551

(22) Filed: Jun. 6, 2008

(51) Int. Cl. B60D 1/07

(52) U.S. Cl. 280/492

(57) ABSTRACT

A dump trailer coupling apparatus is described. The apparatus is joins a vehicle hitch to the push tongue of a trailer in a way that accounts for and permits all movements of the dump trailer when on a roadway and during the dump process, without translating that stress to the hitch. In one embodiment, the apparatus is a swivel coupler including a pair of swivel structures. The first swivel structure enables lateral movement of the trailer with respect to the vehicle. The second swivel structure enables complete dumping of the trailer without stress on the hitch. In another embodiment, the apparatus is a hinged coupler including a support plate, a ball mount and a ball coupler. The ball coupler retains a roller that moves along on the support plate and addresses lateral movement of the dump trailer. The ball coupler includes a hinge connector attached to the trailer push tongue and enables complete dumping of the trailer without stress on the hitch.

### BACKGROUND OF THE INVENTION

1. Field of the Invention

The present invention relates to dump trailer connection devices. More particularly, the present invention relates to devices arranged to enable complete dumping of the trailer while minimizing the stress at the interface between the vehicle hitch and the trailer.

2. Description of the Prior Art

Tilting, or dump, trailers are trailers which have a bed or body portion configured for carrying cargo and for tilting in order to offload, or dump the cargo. Dumping trailers are useful in that they offer a cargo-emptying feature without requiring a dedicated vehicle, such as a dump truck. A dump trailer can be used as needed by attaching it to a tow vehicle, such as a conventional truck, tractor, pick-up truck, sport utility vehicle (SUV), automobile, etc. Once the desired cargo has been hauled and dumped using the trailer, the trailer could then be detached from the tow vehicle, and the tow vehicle is then unencumbered and free to be used for other purposes.

In conventional dump trailers, the dumping mechanism is powered by a separate power source, such as a hydraulic or electric lift mechanism. Such mechanism adds weight and expense to the trailer, and also complexity. However, such a power mechanism is oftentimes required due to the weight of the load in the trailer, the load being prohibitively heavy for allowing the trailer to be tilted upwardly and dumped by hand.

Modified dump trailers have been described. These modified trailers include supplemental structures for removably connecting the trailer to the hitch of a vehicle. The supplemental structures are supposed to permit upward tilting of the forward end of the trailer so that the trailer contents are dumped from the rearward end. However, the supplemental structure does not permit complete dumping without placing substantial stress on the interface between the structure and the hitch. What is needed is an apparatus to couple a dump trailer to a hitch of a vehicle. In particular, what is needed is an apparatus for coupling a dump trailer to a vehicle in which the apparatus enables complete dumping of the trailer with minimal stress on the connection to the vehicle. Preferably, such an apparatus may be connected to a standard vehicle hitch structure.

### SUMMARY OF THE INVENTION

It is an object of the present invention to provide an apparatus to couple a dump trailer to a hitch of a vehicle. It is also an object of the present invention to provide an apparatus for coupling a dump trailer to a vehicle in which the apparatus enables complete dumping of the trailer with minimal stress on the connection to the vehicle. Further, it is an object of the present invention to provide an apparatus for coupling a dump trailer to a vehicle in which the apparatus may be connected to a standard vehicle hitch structure.

These and other objects are achieved with the present invention, which is a dump trailer coupling apparatus. The coupling apparatus is directed to improving the connection to the vehicle hitch so that the dump trailer can be fully operational for complete dumping. The coupling apparatus further provides a better dump trailer connection by minimizing the stress at the connection under all conditions, including over-the-road operation, vehicle and trailer turning, and complete trailer load dumping, all with a fill trailer load.

The dump trailer coupling apparatus of the present invention comes in two primary embodiments. In the first embodiment, the coupling apparatus is a swivel coupler. The swivel coupler includes a pair of swivel structures that are arranged to take away from the hitch location the stress associated with movement of the trailer when traveling and when dumping. In particular, a first swivel structure of the swivel coupler is removably connectable to the push tongue of the dump trailer. A second swivel structure of the swivel coupler is removably connectable to the first swivel structure and to a bar mount that is connectable to the vehicle hitch. The first and second swivel structures swivel or rotate with movement of either or both of the trailer push tongue and the bar mount. That swiveling or rotation reorients the two swivel structures with respect to one another in counteracting response to the movement of the trailer and/or the vehicle. That reorientation reconfigures the relationship between the two and in doing so, reduces the stress at the connection interface.

The second primary embodiment of the coupling apparatus is a hinged coupler. The hinged coupler also acts to counteract the stress at the connection interface that can occur when the push tongue of the dump trailer changes angles, such as during turns and in the process of dumping the trailer. The hinged coupler includes a support plate removably connectable to the bar mount of the vehicle hitch The support plate includes a ball mount and a modified ball coupler that is arranged to removably capture the ball securely while also permitting axial and circumferential rotation of the coupler about the upper portion of the ball. The modified ball coupler is arranged for removable hinged connection to the push tongue of the dump trailer, allowing complete 90° movement of the push tongue from horizontal to vertical orientation during the dumping process without producing stress at the vehicle hitch. The modified ball coupler further includes a roller frame for retaining therein a roller arranged to enable circumferential movement of the modified ball coupler along the perimeter of the support plate while maintaining load support of the push tongue-modified ball coupler interface during swinging movement of the trailer while the vehicle is swaying or turning The arrangement of the hinged coupler substantially eliminates excessive loading at the trailer hitch while allowing complete use of the dump trailer under any load condition.

The dump trailer coupling apparatus of the present invention provides full use of a dump trailer, including complete unloading and all movement, while substantially eliminating stress at the vehicle hitch. This and other advantages of the present invention will become apparent upon review of the following detailed description, the accompanying drawings and the appended claims.

### BRIEF DESCRIPTION OF THE DRAWINGS

FIG. 1 is a side view of a swivel coupler embodiment of the dump trailer coupling apparatus of the present invention connected to the push tongue of a dump trailer.

FIG. 2 is an exploded side view of the swivel coupler.

FIG. 3 is a top view of the swivel coupler connected to the drop drawbar.

FIG. 4 is a side view of the swivel coupler connected to a drop drawbar mountable to a vehicle hitch in a first orientation with respect to the drop draw bar.

FIG. 5 is a side view of the swivel coupler connected to a drop drawbar mountable to a vehicle hitch in a second orientation with respect to the drop draw bar.

FIG. 6 is a side view of a hinged coupler embodiment of the dump trailer coupling apparatus of the present invention connected to the push tongue of a dump trailer and to a bar mount connectable to a vehicle hitch, with the push tongue horizontally oriented such as when trailering the dump trailer.

FIG. 7 is a top view of the support plate of the hinged coupler connected to the bar mount.

FIG. 8 is a side view of the hinged coupler.

FIG. 9 is a front view of the hinged coupler.

FIG. 10 is a side view of the hinged coupler connected to the push tongue of a dump trailer and to the bar mount connectable to the vehicle hitch, with the push tongue vertically oriented such as when completely dumping the dump trailer.

### DETAILED DESCRIPTION OF THE PREFERRED EMBODIMENTS

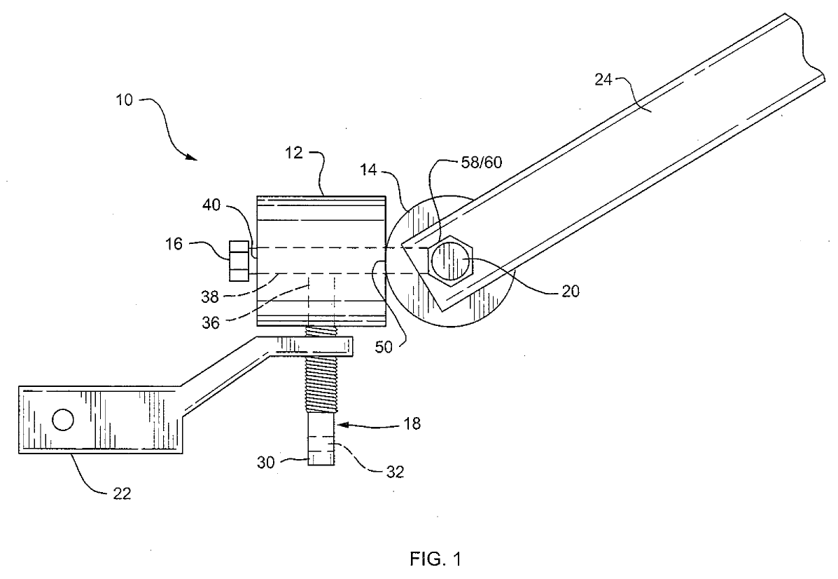

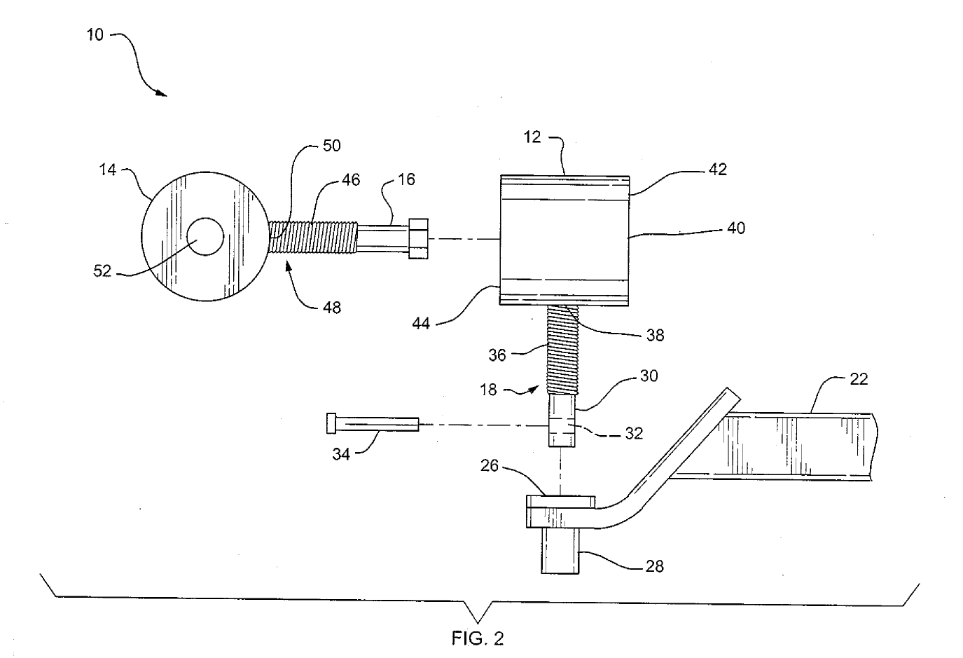

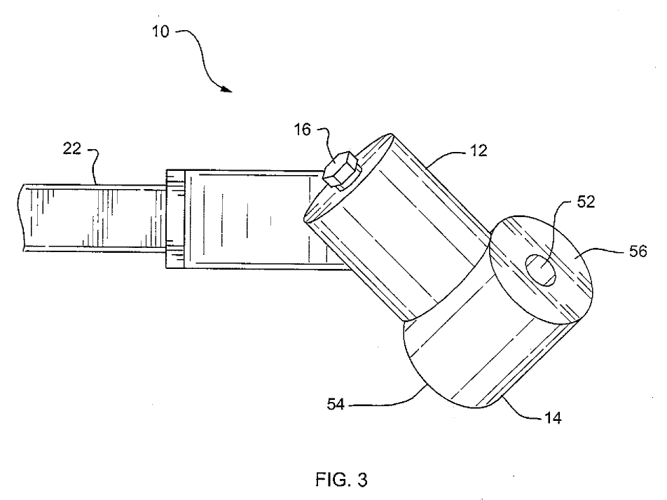

A first embodiment of a dump trailer coupling apparatus of the present invention is a swivel coupler 10 shown in FIGS. 1-5, which swivel coupler 10 is arranged for removably connecting a dump trailer to a vehicle, such as a truck, tractor or SUV, for example. The swivel coupler 10 includes a first swivel cylinder 12, a second swivel cylinder 14, a cylinder connector 16, a mount connector 18 and a push tongue connector 20. The mount connector 18 removably connects the swivel coupler 10 to a hitch mount 22 that is removably connectable to a vehicle hitch (not shown). The hitch mount 22 may be any type of mounting bar including, but not limited to, a drop drawbar of the type shown in FIGS. 2-5, for example. The push tongue connector 20 removably connects the swivel coupler 10 to a push tongue 24 that is removably connectable to a dump trailer (not shown).

The first swivel cylinder 12 is removably connectable to the hitch mount 22 at mount port 26 of the hitch mount 22. The swivel coupler 10 includes a mount port adapter 28 to establish a portable for passage of first end 30 of the mount connector 18 therein. The first end 30 of the mount connector 18 includes a lock port 32 for removably receiving therein a locking pin 34 that ensures the mounting connector 18 remains retained within the mount port 26 when the swivel coupler 10 is to be retained to the hitch mount 22. A second end 36 of the mount connector 18 includes attachment means for removable attachment to the first swivel cylinder 12 at transversely oriented first attachment port 38 thereof. The second end 36 may be threaded, as shown, for removable threading engagement with the first attachment port 38, which may include compatible threading thereof. In this way, the swivel coupler 10 and the hitch mount 22 are removably connected together in a manner that permits the mount connector 18 to rotate in the mount port 26.

With specific reference to FIGS. 1 and 2, the first swivel cylinder 12 includes an axially oriented second attachment port 40 substantially centered on the first swivel cylinder 12 at its axis and extending completely through from first cylinder first face 42 to first cylinder second face 44. The cylinder connector 16 is configured for removable insertion into and through the second attachment port 40. It includes attachment means 46 at a connecting end 48 thereof for removable attachment to second swivel cylinder 14 at transversely oriented first attachment port 50 thereof. The attachment means 46 may be threaded, as shown, for removable threading engagement with the first attachment port 50 of the second swivel cylinder 14, which may include compatible threading thereof. In this way, the first swivel cylinder 12 and the second swivel cylinder 14 are removably connected together in a manner that causes the second swivel cylinder 14 to move with movement of the first cylinder 12.

The second swivel cylinder 14 includes an axially oriented second attachment port 52 substantially centered on the second swivel cylinder 14 at its axis and extending completely through from second cylinder first face 54 to second cylinder second face 56. The push tongue connector 20, which may be a connection bolt, is configured for removable insertion into and through the second attachment port 52 for rotatable motion therein. The push tongue connector 20 includes attachment means 58 at a connecting end 60 thereof for removable attachment to push tongue 24. The attachment means 58 may be threaded for removable threading engagement with the push tongue 24, which may include compatible threading thereof In this way, the swivel coupler 10 and the push tongue 24 are removably connected together in a manner that permits the push tongue connector 20 in the second attachment port 52.

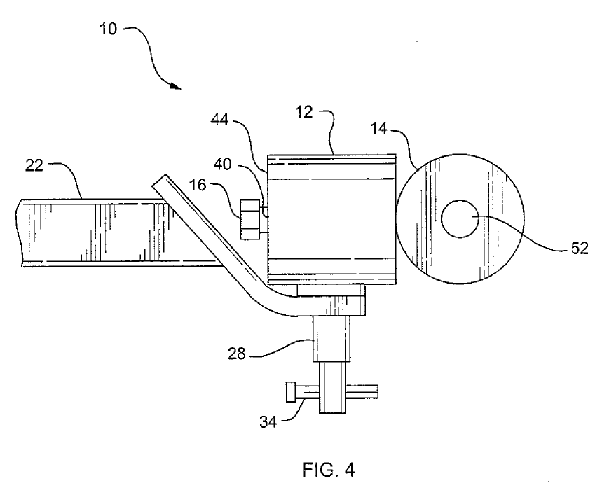

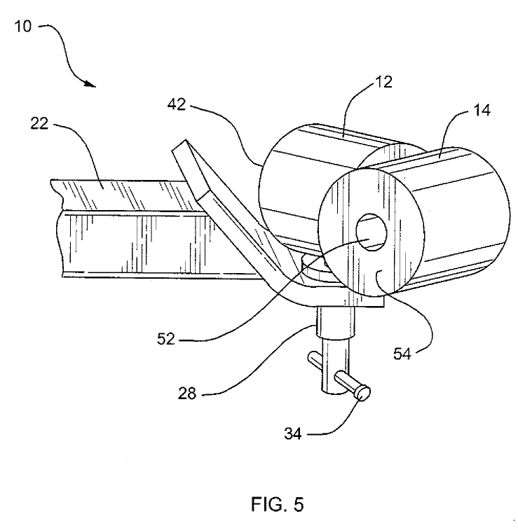

In operation, the swivel coupler 10 enables complete functional operation of the dump trailer, including permitting its tipping to maximum position for complete dumping, without undue stress on the connection of the dump trailer to the vehicle hitch. The swivel coupler 10 also accommodates variable movement of the dump trailer in relation to the vehicle, such as under high speed conditions and through turns, without undue stress on the connection of the dump trailer to the vehicle hitch. When the dump trailer is connected to the vehicle via the swivel coupler 10, lateral movement of one with respect to the other, such as during a turn, causes the mount connector 18 to rotate in the mount port 26. The resultant lateral stress is not absorbed by the mount 24 or by a corresponding conventional ball mount if that is used to connect the dump trailer to the vehicle. Instead, the lateral stress is relieved by the rotation of the swivel coupler I 0 at the first swivel cylinder 12 when the vehicle and dump trailer move in relation to one another. This can be seen when viewing the change of position of the swivel coupler 10 from that seen in FIG. 4 to that seen in FIG. 5.

When the dump trailer has been moved to a desired location for the purpose of unloading its load, the swivel coupler 10 is configured to permit its complete unloading without generating any excess stress at the connection between the vehicle and the dump trailer. When the vehicle is backed up and the dump trailer prevented from making any rearward movement, such as by blocking its rear wheels, for example, the swivel coupler 10 is arranged to permit the push tongue 24 to rotate from a horizontal orientation to a vertical orientation. As the vehicle backs up, it forces the push tongue 24 to pivot at its connection to the dump trailer. This pivoting is enabled by the swivel coupler 10 because the push tongue connector 20 is free to rotate in the second attachment port 52 of the second swivel cylinder 14 so that the vehicle may continue to back up as the push tongue 24 moves to the vertical orientation, including substantially perpendicular to its horizontal orientation. FIG. 1 illustrates an interim position of the push tongue 24 as it moves to or from the vertical orientation. Complete trailer dump occurs when the push tongue 24 is substantially vertically oriented. The rotation of the push tongue connector 20 in the second swivel cylinder 14 relieves any stress at the vehicle to trailer connection that would otherwise occur during the process of dumping the trailer.

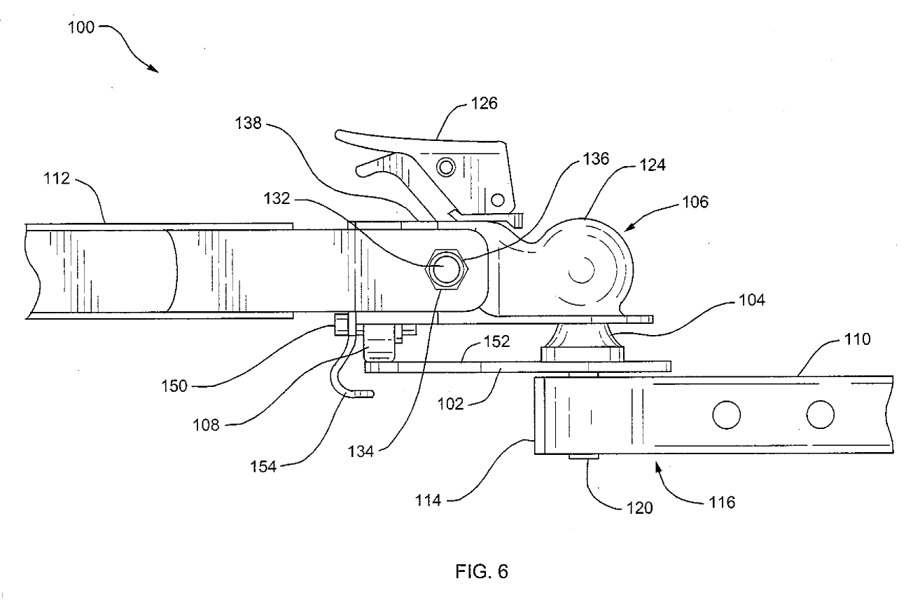

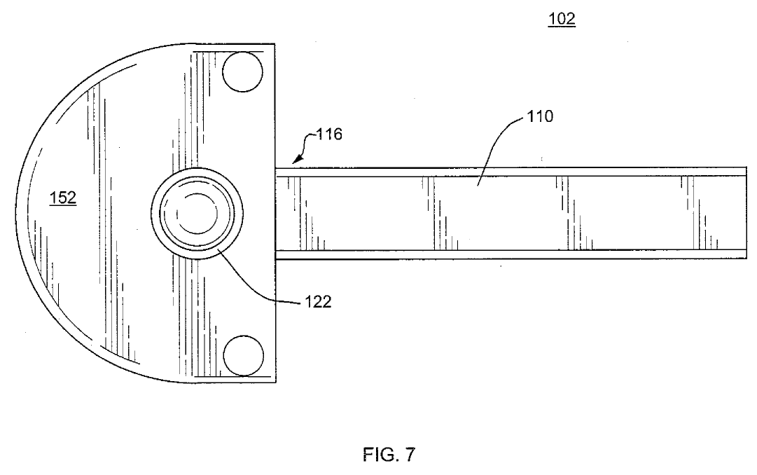

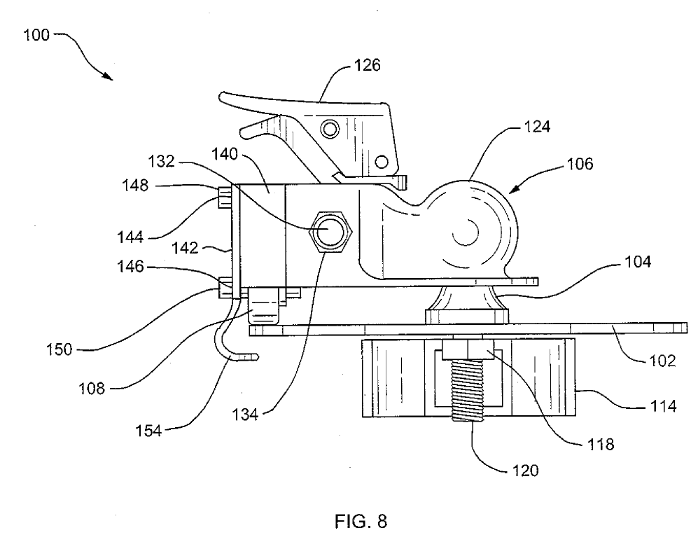

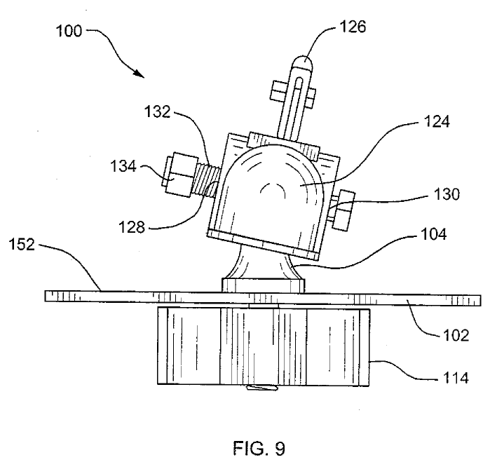

A second embodiment of a dump trailer coupling apparatus of the present invention is a hinged coupler 100 shown in FIGS. 6-10, which hinged coupler 100 is also arranged for removably connecting a dump trailer to a vehicle, such as a truck, tractor or SUV, for example. The hinged coupler 100 includes a support plate 102, a hitch ball 104, a ball coupler 106 and a roller 108. The support plate 102 removably connects the hinged coupler 100 to a hitch mount 110 that is removably connectable to a vehicle hitch (not shown). The hitch mount 110 may be any type of mounting bar, such as the extension bar shown in FIG. 6. The ball coupler 106 removably connects the hitch ball 104 to a push tongue 112 that is removably connectable to a dump trailer (not shown).

The support plate 102 includes a plate flange 114 for fitting to end 116 of the hitch mount 110. The support plate 102 further includes a ball attachment means, such as nut 118. The nut 118 is arranged for removable engagement with attachment end 120 of hitch ball 104, which attachment end 120 may be threaded for threading engagement with the nut 118, for example. The attachment end 120 of the hitch ball 104 is arranged to pass through plate port 122 of the support plate 102 and be removably retained therein by the nut 118 or other suitable attachment arrangement. When the nut 118 is substantially completely engaged with the attachment end 120, the hitch ball 104 is joined to the support plate 102 over end 116 of the hitch mount 110.

The ball coupler 106 includes ball cap 124 sized to fit loosely enough on the hitch ball 106 to allow the swivel about on the hitch ball when placed thereon. The ball coupler 106 includes a releasable safety lock 126 of the type those of ordinary skill in the art will recognize to be suitable for releasably retaining the ball cap 124 engaged with the hitch ball 104. The ball coupler 106 further includes first coupler port 128 and second coupler port 130 for removably retaining therein push tongue hinge 132. The push tongue hinge 132 may be a bolt that is removably affixed to attachment means such as nut 134 or other suitable means arranged to enable rotatable movement of the push tongue hinge 132 while retained in the first coupler port 128 and the second coupler port 130. The push tongue hinge 132 is also arranged for rotatable engagement through first tongue port 136 and second tongue port 138. When the first tongue port 136 is positioned adjacent to the first coupler port 128, the second tongue port 138 is positioned adjacent to the second coupler port 130 and the push tongue hinge 132 is passed through and retained in all four such ports, the push tongue 112 is removably and hingedly joined to the ball coupler 106.

The ball coupler 106 further includes a roller frame 140 that provides a guide for the roller 108. A frame plate 142 includes a first frame plate port 144 and a second frame plate port 146, each arranged to permit passage therethrough of respective attachment means. A frame plate attachment means, such as removable frame bolt 148 connects the frame plate 142 to the roller frame 140 of the ball coupler 106. Additionally, a roller attachment means, such as roller bolt 150, also connects the frame plate 142 to the roller frame 140. The roller bolt releasably retains the roller 108 in the roller frame 140 of the ball coupler 106 such that when the ball coupler 106 is engaged with the ball 104 on the support plate 102, the roller 108 contacts an upper surface 152 of the support plate 102. The frame plate 142 includes a safety flange 154 arranged to extend under the support plate adjacent to a lower surface 156 thereof when the ball coupler 106 is engaged with the ball 104. The safety flange 154 aids in maintaining the orientation of the frame plate with the support plate 102.

In operation, the hinged coupler 100 enables complete functional operation of the dump trailer, including permitting its tipping to maximum position for complete dumping, without undue stress on the connection of the dump trailer to the vehicle hitch. The hinged coupler 100 also accommodates variable movement of the dump trailer in relation to the vehicle, such as under high speed conditions and through turns, without undue stress on the connection of the dump trailer to the vehicle hitch. When the dump trailer is connected to the vehicle via the hinged coupler 100, lateral movement of one with respect to the other, such as during a turn, causes the ball coupler 106 to rotate about laterally on the ball 104, with the roller 108 rolling along on the support plate 102 to maintain uniform loading on the connection between the ball coupler 106 and the hitch ball 104 during such lateral rotation. The resultant lateral stress is not absorbed by the hitch mount 110 or by a corresponding conventional ball mount if that is used to connect the dump trailer to the vehicle. Instead, the lateral stress is relieved by the rotation of the ball coupler 106 on the hitch ball 104 when the vehicle and dump trailer move in relation to one another.

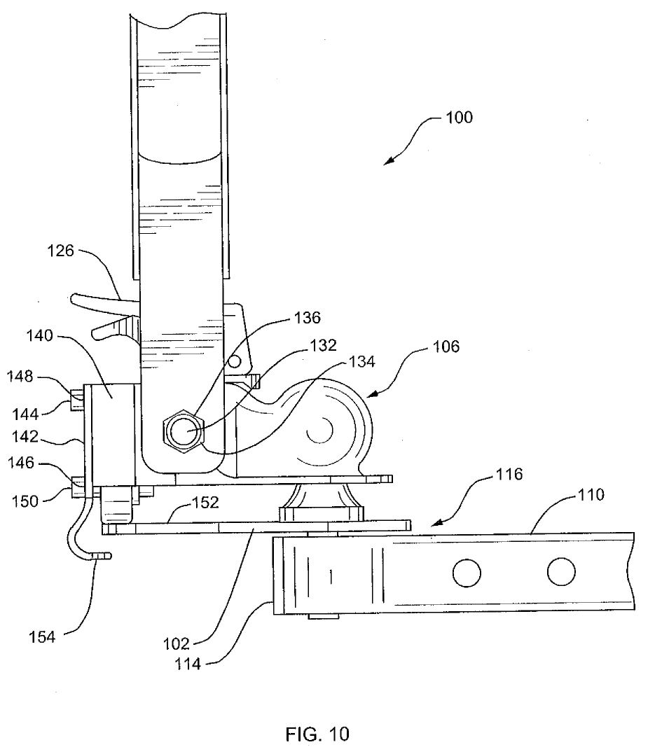

When the dump trailer has been moved to a desired location for the purpose of unloading its load, the hinged coupler 100 is configured to permit its complete unloading without generating any excess stress at the connection between the vehicle and the dump trailer. When the vehicle is backed up and the dump trailer prevented from making any rearward movement such as by blocking its rear wheels, for example, the hinged coupler 100 is arranged to permit the push tongue 112 to rotate from a horizontal orientation, as shown in FIG. 6, to a vertical orientation, as shown in FIG. 10. As the vehicle backs up, it forces the push tongue 112 to pivot at its connection to the dump trailer. This pivoting is enabled by the hinged coupler 100 because the push tongue hinge 132 is free to rotate in the first coupler port 128, the second coupler port 130, the first tongue port 136 and the second tongue port 138 so that the vehicle may continue to back up as the push tongue 112 moves to the vertical orientation, including substantially perpendicular to its horizontal orientation. FIG. 6 shows the push tongue 112 in a horizontal orientation and FIG. 10 shows the push tongue in a vertical position, wherein each position is enabled without stress at the ball coupler 106 to ball 104 interface. Complete trailer dump occurs when the push tongue 112 is substantially vertically oriented as in FIG. 10.

The coupling apparatus of the presented invention represented by the swivel coupler 10 and the hinged coupler 100, is directed to improving the connection to the vehicle hitch so that the dump trailer can be fully operational for complete dumping. The coupling apparatus further provides a better dump trailer connection by minimizing the stress at the connection under all conditions, including over-the-road operation, vehicle and trailer turning, and complete trailer load dumping, all with a full trailer load. The present invention has been described with respect to various combinations of specified components in two example embodiments. Nevertheless, it is to be understood that various modifications may be made without departing from the spirit and scope of the invention as described by the following claims.

What is claimed is:

1. A dump trailer coupling apparatus comprising:
a. a first swivel structure;
b. a second swivel structure removably connected to the first swivel structure;
c. means for removably connecting the first swivel structure to a hitch mount, wherein the means for connecting the first swivel structure is arranged to permit rotational movement of the first swivel structure with respect to the hitch mount; and
d. means for removably connecting the second swivel structure to a push tongue of a dump trailer, wherein the means for connecting the second swivel structure is arranged to permit pivotal movement of the push tongue with respect to the second swivel structure.

2. The apparatus as claimed in claim 1 wherein the first swivel structure is a first swivel cylinder and the second swivel structure is a second swivel cylinder.

3. The apparatus as claimed in claim 1 wherein the means for removably connecting the first swivel structure to the hitch mount is a connecting bolt, a portion of which is configured to permit free rotation of the connecting bolt in a receiving port of the hitch mount.

4. The apparatus as claimed in claim 3 wherein the connecting bolt includes a port, the apparatus further comprising a locking pin arranged for placement in the port of the connecting bolt below the receiving port of the hitch mount.

5. The apparatus as claimed in claim 1 wherein the second swivel structure includes an attachment port and the means for removably connecting the second swivel structure to the push tongue is a connection bolt, a portion of which is configured to permit free rotation of the connection bolt in the attachment port of the second swivel structure.

6. A dump trailer coupling apparatus comprising:
a. a support plate having an upper surface;
b. a ball member removably connectable to the support plate on the upper surface thereof;
c. a ball coupler removably connectable to the ball member;
d. a roller retained to the ball coupler and arranged to roll on and remain in contact with the upper surface of the support plate when the ball coupler is engaged with the ball member;
e. means for removably connecting the support plate to a hitch mount; and
f. means for removably and hingedly connecting the ball coupler to a push tongue of a dump trailer, wherein the means for connecting the ball coupler is arranged to permit pivotal movement of the push tongue with respect to the ball coupler.

7. The apparatus as claimed in claim 6 further comprising a releasable safety lock connected to the ball coupler.

8. The apparatus as claimed in claim 6 wherein the roller is retained to the ball coupler by a roller frame of the ball coupler.

9. The apparatus as claimed in claim 6 wherein the means for removably connecting the support plate to the hitch mount is an attachable bolt of the ball member arranged for removable insertion and retention to a receiving port of the hitch mount and a port of the support plate.

10. The apparatus as claimed in claim 6 wherein the means for removably and hingedly connecting the ball coupler to the push tongue is a rotatable bolt.
